(19) United States
(12) Patent Application Publication
(10) Pub. No.: US 2007/0075105 A1
(43) Pub. Date: Apr. 5, 2007

(54) Trailable backpack

(76) Inventor: Raymond R. Petrin, San Carlos, CA (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 11/243,958

(22) Filed: Oct. 4, 2005

(51) Int. Cl. A45F 3/14; A45F 4/02; B62B 1/00; B62D 51/04

(52) U.S. Cl. 224/153; 224/184; 280/1.5; 280/47.26

(57) ABSTRACT

A combination trailable backpack for use carrying goods over a variety of types of terrain, the trailable backpack consists of a backpack-type harness portion, a rigid and essentially vertical support member coupled to the shoulder harness portion, a trailable portion having a yoke section coupled to the essentially vertical support member such that the yoke can be slidably moved parallel with the vertical support member. The trailable portion that has an openable and closeable enclosure portion for storing goods to be transported. Moreover, the trailable portion also has one or more wheels for providing rolling support to the trailable portion, such that when the yoke is moved to a position in a lower part of the vertical support member, the wheel(s) provide rolling support to the trailable portion. When the yoke is moved to a position in an upper part of the vertical support member, the wheel(s) rise off the ground and the entire trailable backpack is supported by the backpack-type harness portion.

### FIELD OF THE INVENTION

The present invention relates generally to a multi-functional trailable backpack and more particularly to a backpack with a trailer portion with wheel(s) that allows user to optionally change the mode of use from standard loaded backpack to pulled, trailable cart.

### BACKGROUND OF THE INVENTION

Luggage comprises any number of bags, cases and containers which hold a traveler's articles during transit. Luggage has changed over time. Nowadays, smaller and more lightweight suitcases and bags that can be carried by an individual have become the main form of luggage.

The simplest form of backpack, also known as rucksack and/or knapsack, is a sack carried on one's back and secured with two straps that go over the shoulders and below and underneath the armpits. The shoulders are better suited for bearing heavy weights for long periods of time than hands or arms, so backpacks are often used for that purpose. Backpacks designed for backpacking are considerably more complex since they have to carry heavy weight for relatively longer time.

Backpacks or packs come in two main models: internal-frame and external-frame. In addition to the two shoulder straps, modern packs always have a padded hip belt. The hip belt carries most of the pack's weight, because the pelvis is sturdier than the structure of the shoulders; this also lowers the hiker's center of gravity.

An external-frame pack is constructed around a metal (usually aluminum) frame. The frame has a system of straps and pads to keep its metal parts from contacting the body, with the added benefit of improved ventilation and decreased sweatiness. The frame of internal-frame packs is contained entirely inside the pack and consists of strips of either a specially designed polymer or metal that molds to one's back to provide a good fit.

However, regardless of design features, the weight of any backpack and its carrying load are primarily beared by the users vertically against gravitational pull.

In U.S. Pat. No. 4,664,395, McCoy teaches a Multi-purpose Uniaxial Litter Enginery or MULE which is a single wheeled user propelled, load assisting device. A harness unit attached to a user worn frame unit which is pivotally attached to an elongated load bearing frame unit having a retractable support unit and a wheel unit; wherein the retractable support unit allows the assembly to be deployed in a stand alone walk-into, or walk-out-of mode, and the assembly is further provided with independent first and second brake and brake actuating units, wherein variable braking is applied to the assembly while in motion, and positive braking is applied to the assembly in the stand alone mode. However, unlike the present invention, the MULE only allows user to drag carrying load horizontally using a wheel system.

There is little prior art which contains the similar concept of the '395 patent with different design features. In U.S. Pat. No. 5,385,355, Hoffman teaches a monowheel travois assembly which comprises a load-carrying frame having a lower end and an upper end. In U.S. Pat. No. 5,769,431, Cordova teaches a similar backpack and load conveyance apparatus which receives and conveys numerous types of items through a conventional type backpack shoulder and waist support assembly. In U.S. Pat. No. 6,139,033, Western teaches a stable monowheel travois with counterweight feature for carrying a load behind an individual comprising a frame assembly with a forward section and a rear section, the rear section adjustably engaged with an axle that is rotatably coupled to a wheel. However, ultimately, none of the above-mentioned prior arts allows users to lift the entire system in order to switch the mode of supporting and transporting the carrying load.

There are also backpack with wheels and pull handle available in the market. These backpacks have wheel system(s) installed that allow user to drag the luggage by hand with a pull handle. However, unlike the present invention, these backpacks do not allow users to change mode of bearing without dislodging the backpack from his/her shoulders. Besides, users are dragging the backpack with their hand rather than their shoulders.

### ADVANTAGES AND SUMMARY OF THE INVENTION

The present invention provides significant increment of individual portage comparing to traditional backpacks. With a trailer portion of the present invention, instead of lifting or carrying up the entire weight of the carrying load, users can dissipate part of the weight to the trailer portion and utilize the wheel system to drag or trailer the carrying load horizontally.

Another object and advantage of the present invention is to provide the flexibility that users can optionally carry the entire load primarily on their shoulders in the backpack position, or pull/trail part of the load with the trailer and wheel portions in use.

Another object and advantage of the present invention is to provide the convenient conversion from backpack or carrying to dragging or trailing mode, and vice versa. With the pulley system installed, users can change from one mode to another without dislodging from their shoulders.

Yet another object and advantage of the present invention is to provide an easy way for temporarily dislodging part of the carrying weight by switching to the trailering or trailing mode. With the brake system in the trailer portion, users can take a resting position without dislodging the strap portions.

Another object and advantage of the present invention is to allow users to pull/drag heavy load by typically stronger body parts such as legs, thighs and trunk. Whereas pull-handled backpacks require users' arm and hand strength which is typically weaker.

Further objects and advantages of the present invention will be come apparent through the following descriptions, and will be included and incorporated herein.

The present invention is a trailable backpack which can be used alternatively as a conventional, shoulder-mounted backpack and as a wheeled trailer coupled to the upper torso of a user. In an embodiment, the present invention consists of a shoulder-supported carrying frame structure having shoulder straps and one or more rigid, essentially vertical support members and a trailable portion having one or more rotatable wheels, an enclosure portion, and a coupling portion slidably attached to the one or more vertical support members.

In an embodiment, the present invention further comprises manually operated hoisting mechanism for manually repositioning the trailable portion adjacent the shoulder supported carrying frame structure.

In an embodiment of the present invention, the manually operated hoisting mechanism comprises one or more handle portions.

In an embodiment of the present invention, the manually operated hoisting mechanism comprises a ratchet-operated, locking mechanism drive assembly.

In an embodiment, of the present invention, the trailable backpack further comprises a hydraulically operated hoisting mechanism for automatically repositioning the trailable portion adjacent the shoulder supported carrying frame structure.

In an embodiment, of the present invention, the trailable backpack further comprises an electrically operated hoisting mechanism for automatically repositioning the trailable portion adjacent the shoulder supported carrying frame structure.

In an embodiment, of the present invention, in which the one or more rotatable wheels are coupled to the trailable portion with one or more leg extension portions.

In an embodiment, of the trailable portion of the present invention, there are one or more leg extension portions fold as desired.

In an embodiment, of the present invention, the coupling portion comprises a yoke portion.

In an embodiment, of the present invention, one or more vertical support members comprise one or more tubular members.

In an embodiment, of the present invention, the coupling portion comprises one or more roller bearings and in which the one or more vertical support members comprise one or more tubular members having internal tracks, wherein the one or more roller bearings roll up and down the one or more internal tracks disposed within the vertical support members.

In an embodiment, of the present invention, the coupling portion comprises one or more roller bearings and in which the one or more vertical support members comprise one or more tubular members having external tracks, wherein the one or more roller bearings roll up and down the one or more external tracks disposed externally on the vertical support members.

The present invention is also a method of transporting goods using a trailable backpack. In an embodiment, the trailable backpack has a shoulder supported frame and shoulder harness and a wheeled trailer portion which consists of an enclosure for carrying goods positionably attached thereto. The method consists of the following steps: Supporting the trailable backpack on a user's shoulders, pulling the trailable backpack while the wheel of the trailer portion rolls over the ground as desired and re-positioning the wheeled trailer portion and enclosure such that the weight of the wheeled trailer portion is fully supported off the ground by the shoulder harness.

The present invention is also a combination trailable backpack for use carrying goods over a variety of types of terrain. In an embodiment, the trailable backpack consists of in combination of a backpack-type harness portion, a rigid, essentially vertical support member coupled to the shoulder harness portion, a trailable portion having a yoke section coupled to the essentially vertical support member such that the yoke can be slidably moved parallel with the vertical support member. The trailable portion has an openable and closeable enclosure portion for storing goods to be transported. The trailable portion also has a wheel for providing rolling support to the trailable portion. In an embodiment, when the yoke is moved to a position in a lower part of the vertical support member, the wheel provides rolling support to the trailable portion. In another embodiment, when the yoke is moved to a position in an upper part of the vertical support member, the wheel rises off the ground and the entire trailable backpack is supported by the backpack-type harness portion.

In an embodiment, of the present invention, the trailable backpack further comprises the backpack-type harness which has a shoulder harness.

In an embodiment, of the present invention, the backpack-type harness comprises a waist support device, said wait support device comprising a waits belt, harness or hip support structure.

It is yet a further object and advantage of the present invention to provide a device which is useful for backpacking or trailing in all types of terrain, i.e., on flat land, through forests, up mountains, etc.

It is yet a further object and advantage of the present invention to provide a compact, collapsible and folding trailable backpack. The prior aft devices are elongated, cannot be folded up and carried completely, and are cumbersome to use in.

### BRIEF DESCRIPTION OF THE DRAWINGS

FIG. 1A is a representative side view of an embodiment of a trailable backpack 100 of the present invention without the backpack enclosure portion 120 in the trailing mode.

FIG. 1B is a representative side view of an embodiment of a trailable backpack 100 of the present invention with the enclosure portion 120 in the trailing mode.

FIG. 2A is a representative side view of an embodiment of a trailable backpack 100 of the present invention without the enclosure portion 120 in the backpack/carrying mode.

FIG. 2B is a representative side view of an embodiment of a trailable backpack 100 of the present invention with the enclosure portion 120 in the backpack/carrying mode.

FIG. 3A is a representative front view showing the ball-and-socket joint 302 mechanism and sliding bar 202 mechanism.

FIG. 3B is a representative view showing sliding bar 202 mechanism.

FIG. 4 is a representative rear view of a trailable backpack 100 of the present invention without the backpack enclosure portion 120.

FIG. 5A, 5B, 5C and 5D are representative side views showing the apparatus and method of use of an embodiment of a trailable backpack 100 of the present invention switching from trailing mode to backpack/carrying mode.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

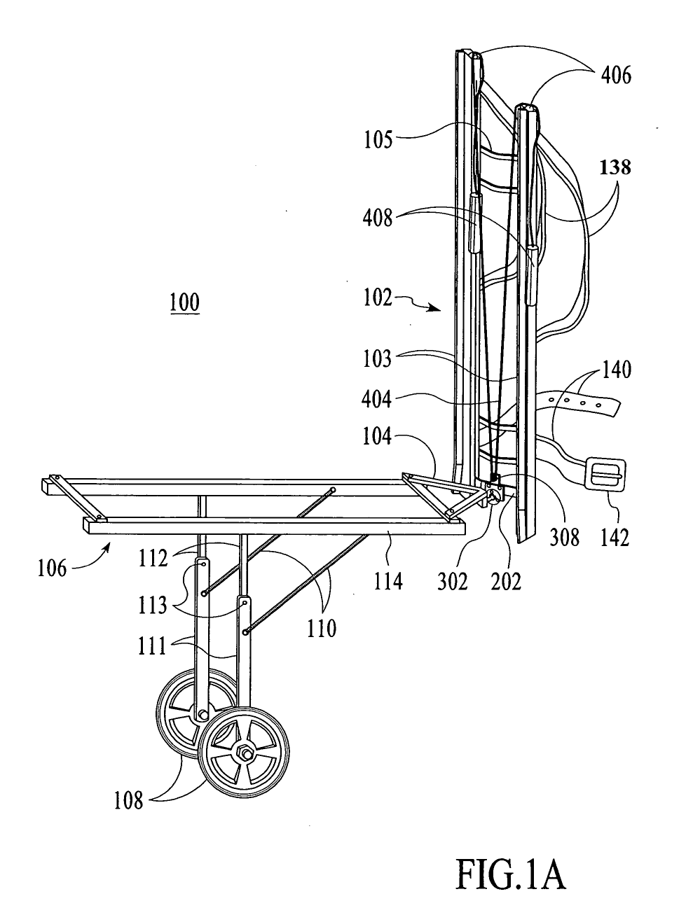

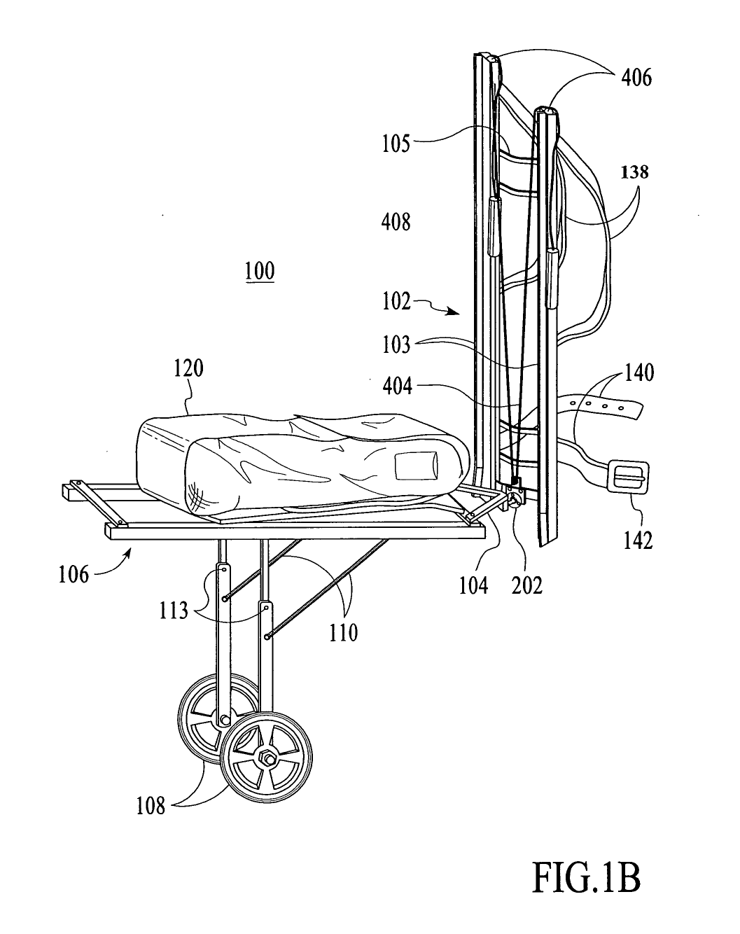

FIG. 1A is a representative side view of an embodiment of a trailable backpack 100 of the present invention without the enclosure portion 120 in the trailing mode. As shown in FIG. 1A, trailable backpack 100 of the present invention mainly consists of back frame portion 102, yoke 104, trailer portion 106 and wheel assembly portion 111.

In an embodiment, back frame portion 102 of the present invention 100 consists primarily of a U-shaped structure. The main function of back frame portion 102 of the present invention 100 is to provide an anchor for both user's shoulders and trailer portion 106 including enclosure portion 120. The whole structure is made of, in an embodiment, light and strong materials such as aluminum, steel alloy, titanium alloy and/or any other material that meets the requirements. In an embodiment, back frame portion 102 consists of two vertical poles 103 which are parallel and/or otherwise and should have a length of approximately between 0.5 m-1.5 m. In an embodiment, vertical poles 103 are hollow structures with grooves 320 to allow sliding bar 202 to slide up and down. A couple of cables 404 are connected to sliding bar 202 at cable eye 308. In an embodiment, cables 404 go across the top of each vertical pole 103 at directional pulley 406 to the front of the trailable backpack 100 of the present invention. Handle 408 is coupled at the end of each cable 404.

The two vertical poles 103 are connected by a plurality of horizontal poles 105 in a rigid, frame-type structure. The shape of horizontal poles 105 can be curved slightly outward towards the rear in order to conform to the contour of the human back. In an embodiment, horizontal poles 105 are coupled with the two vertical poles 103 by mechanical means like wielding, bolts/nuts and/or other methods. The distance between the two vertical poles 103 is determined by the length of horizontal poles 105, and in an embodiment, should not exceed 1.5 m. Alternatively, the two vertical poles 103 can merge into a single, unitary, central vertical pole or slider for supporting the enclosure portion 120 as it moves up and down. In an embodiment, two shoulder straps 138 are anchored on either the two vertical poles 103 and horizontal poles 105. The function of two shoulder straps 138 is to provide an anchor for user 602 to either lift in the carrying mode or drag in the trailing mode the trailable backpack of the present invention 100. In an embodiment, a couple of standard, padded-type waist belt/straps 140 are attached to the lower portion of the two vertical poles 103 respectively. Waist belt/straps 140 are to wrap around user's 602 waist or hip area. The two lose ends of waist belt/straps 140 are secured to each other with a clasp/couple device 142 with optionally a manual locking mechanism. With the waist belt/straps 140 in place, user 602 can dissipate a large portion of the entire load from the shoulders to the waist/hips area. In an embodiment, the waist belt 140 can support between about 25% to about 90% of the total weight of the foldable and trailable backpack 100 of the present invention.

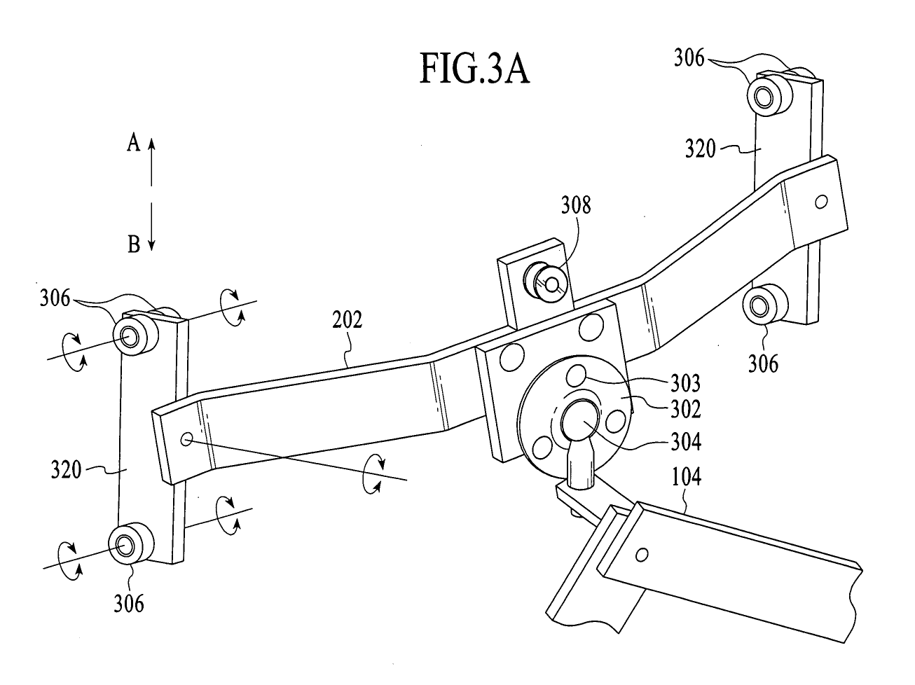

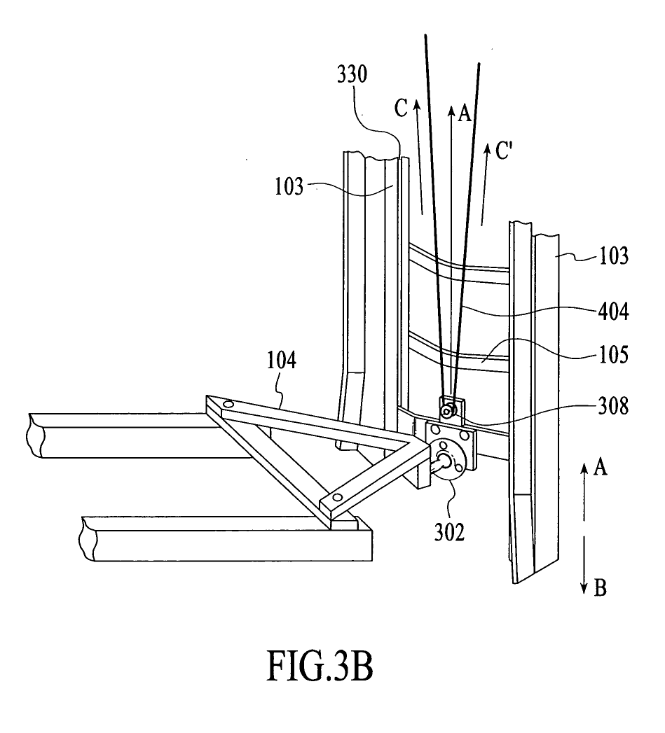

As best shown in FIG. 1A and FIG. 3, yoke-like traveler assembly portion 104 is connected to the center of sliding bar 202 by a ball-and-socket joint 302 and/or other mechanism which allows a full 360° movement of the yoke or traveler assembly portion 104.

In an embodiment, trailer portion 106 is connected to the bottom of the back frame portion 102 by the yoke 104. Trailer portion 106 consists of square frame 114 which is used as a platform to hold carrying loads. One end of square frame 114 is connected rigidly to yoke 104 by mechanical means. A pair of leg portions 111 are coupled rigidly to two respective side bars of square frame 114. In an embodiment, leg portions 111 extend perpendicularly at approximately halfway lengthwise of side bars of square frame 114. Leg extension portion 112 is then coupled at the other end of each leg portion 111. The connection joint 113 between the two portions is flexible to allow 360° revolvement of leg extension portion around the connection joint 113. The other end of leg extension portion 112 is subsequently connected mechanically to wheels 108. To absorb and dampen vibration and shock created by uneven ground surface, as best shown in FIG. 1A and 1B, a spring 110 is installed between the middle of leg extension portion 111 and the base of side bars of square frame 114. In an embodiment, wheels 108 are pneumatic and/or foam filled and should be made of light materials to minimize lifting weight during the backpack/carrying mode. In an embodiment, the dimension of wheels 108 should be approximately around the range of 12″ to 15″ in diameter.

FIG. 1B is a representative side view of an embodiment of a trailable backpack 100 of the present invention with the enclosure portion 120 in the trailing mode. As shown in FIG. 1B, enclosure portion 120 and/or other loads can be placed on the horizontal surface created by square frame 114. Enclosure portion 120 and/or other loads can be optionally secured to square frame 114 by means such as straps, clips, etc., to avoid falling off the trailer portion 106 during movement.

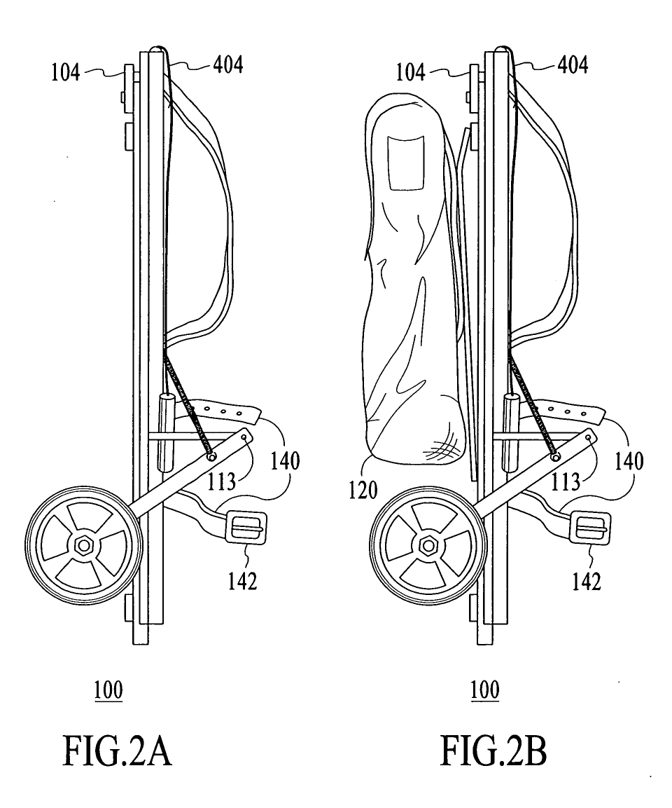

FIG. 2A is a representative side view of an embodiment of a trailable backpack 100 of the present invention without the enclosure portion 120 in the backpack/carrying mode. As shown, trailer portion 106 can be slid along the length of the two vertical poles 103 at sliding bar 202. In so doing, the entire trailer portion 106 will be slid towards the back frame portion 102 and switched to backpack/carrying mode.

FIG. 2B is a representative side view of an embodiment of a trailable backpack 100 of the present invention with the enclosure portion 120 in the backpack/carrying mode. As shown in FIG. 2B, enclosure portion 120 and/or other loads can be attached to yoke 104 and/or other parts of trailable backpack 100 by mechanical means such as hooks, straps etc. Users can then lift the entire structure of trailable backpack 100 through shoulder straps 138.

FIG. 3A is a representative front view showing the ball-and-socket joint 302 mechanism and sliding bar 202 mechanism of trailable backpack 100 of the present invention. The ball-and-socket joint 302 further comprises a ball portion 304 and socket portion 303. As shown in FIG. 3A, ball-and-socket joint 302 is rigidly secured to sliding bar 202 at the socket portion 303 and to yoke 104 at the ball portion 304. The ball-and-socket mechanism allows yoke 104 and subsequently the entire trailer portion 106 to rotate and revolve freely at the joint 302. The movement allows greater flexibility during the trailing mode when users are making turns. Also, it provides the required flexibility when trailer portion 106 is slid upwards during the backpack/carrying mode.

As shown in FIG. 3A, the two ends of sliding bar 202 are attached to vertical block 320. In an embodiment, there are a plurality of sliding wheels 306 which enable the entire sliding bar 202 to slide along the length of vertical poles 103 in direction A and B. It will be understood that the sliding wheels 306 can be positioned inside a rigid, tubular track as shown or mounted on the exterior of one or more track-like vertical pole members.

FIG. 3B is a representative view showing sliding bar 202 mechanism of the trailable backpack 100 of the present invention. In an embodiment, vertical blocks 320 are inserted inside each sliding groove 330 of the hollow vertical poles 103. In so doing, the entire sliding bar 202 is able to slide along the length of vertical poles 103 in direction A and B. As shown in FIG. 3B, when cables 404 are pulled in direction C, they will lift sliding bar 202 at cable eye 308.

In an embodiment, the trailing portion 106 can slide up two vertical pole or slider members in a manner similar to the operation of a BFI box or garbage container/receptacle being loaded onto a flat-bed BFI-type tow truck, optionally having a pivoting lower bottom plate or tilting surface upon which the trailing portion 106 can be slidably loaded. In this embodiment, the yoke portion 104 can be replaced by a pair of wheels or bearings or other bulkhead portions which slide directly up vertical pole or track members 103.

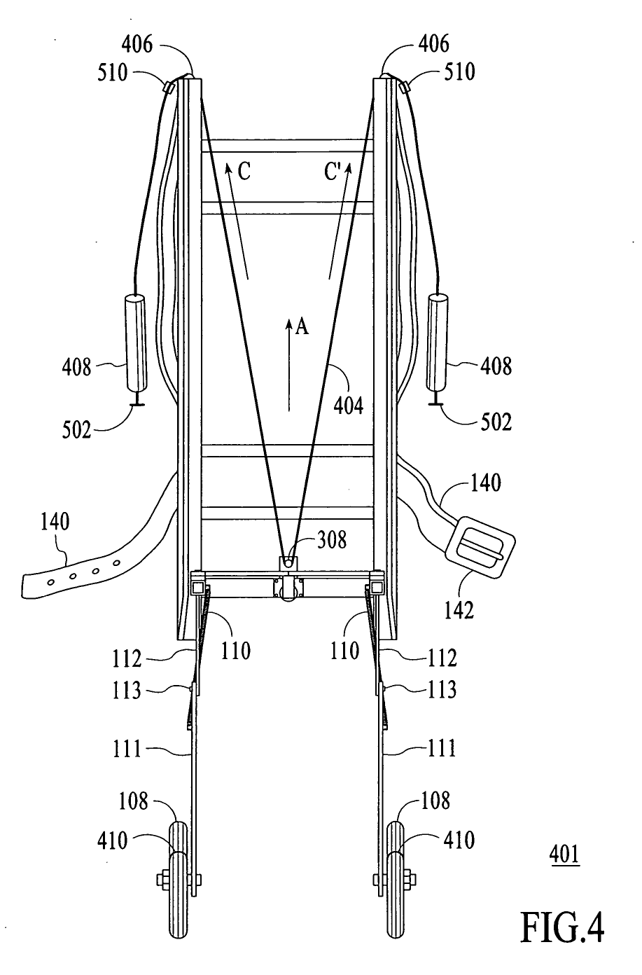

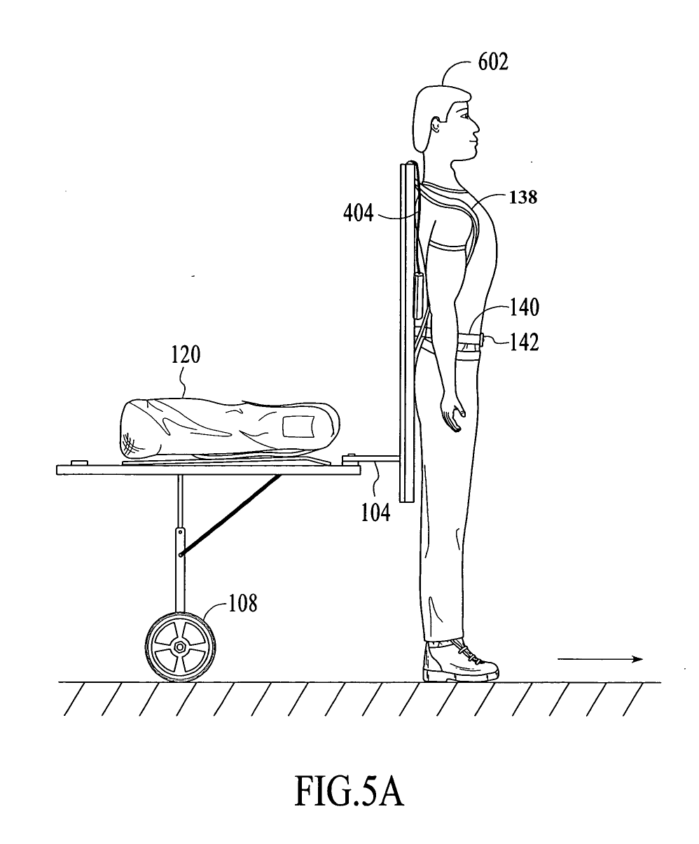

FIG. 4 is a representative rear view of a trailable backpack 100 of the present invention without the backpack enclosure portion 120. As shown in FIG. 4, in an embodiment, a directional pulley 406 is installed near the top of two vertical poles 103 of back frame portion 102 of the present invention 100. In an embodiment, a couple of cables 404 go through directional pulley 406 from the front to the back side of the back frame portion 102. One end of the cables is connected to a handle 408 and the other end is connected to cable eye 308. When user pull cables 404 in direction C, in an embodiment, cables 404 will slide through directional pulleys 406. Subsequently, cables 404 will lift square frame 114 in direction A at cable eye 308 coupled on sliding cross bar 202. In an embodiment, the entire trailer portion 106 will be lifted and revolved at the ball-and-socket joint 302. As shown in FIG. 4, in an embodiment, the cable system is installed to lift and slide trailer portion 106 while user is still carrying back frame portion 102 on their shoulders through shoulder straps 138.

Optionally, in an alternative embodiment, a pulley operated sliding system which consists of a plurality of pulleys can be installed to facilitate the transition from the trailing mode to carrying mode. Pulley operated system which consists of a plurality of pulleys could be coupled mechanically on respective horizontal poles 105. Cables 404 can first go through the alternative embodiment instead of being directly connected to cable eye 308. The size ratio of pulleys are predetermined to ensure users could lift and slide the entire trailer portion 106 and switch from trailing to backpack/carrying mode without harmful physical strain.

A locking system could be installed at handle 408, directional pulleys 406 and/or other places along the pulley operated sliding system 401 to maintain position of cables 404 once desirable lifting is achieved. As shown in FIG. 4, in an embodiment, ratchet roll brake 510 is installed on cables 404 between directional pulleys 406 and handle 408. In an embodiment, the ratchet roll brake 510 functions as a unidirectional and automatic locking system when cables 404 are pulled. Trailer portion 106 will be lifted and locked in position automatically instead of falling back to the ground by gravity even after user stops applying the pulling pressure. The ratchet roll brakes 510 enable users to switch from trailing mode to backpack/carrying mode in several stages. In an embodiment, ratchet brake release 502 in installed in handles 408 to release ratchet roll brakes 510.

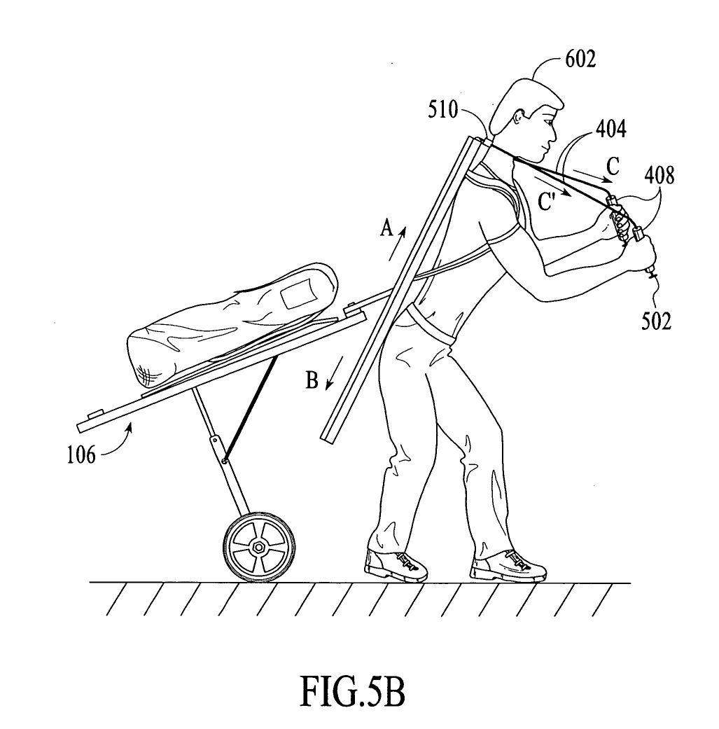

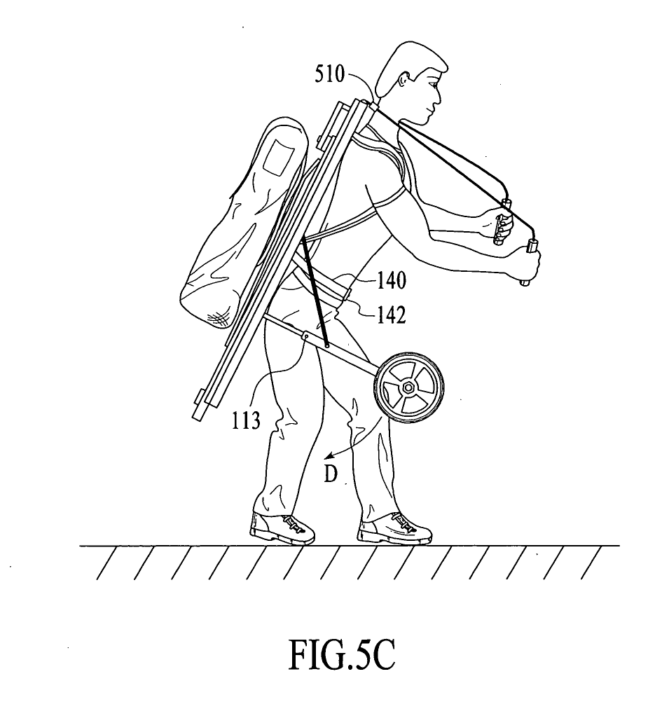

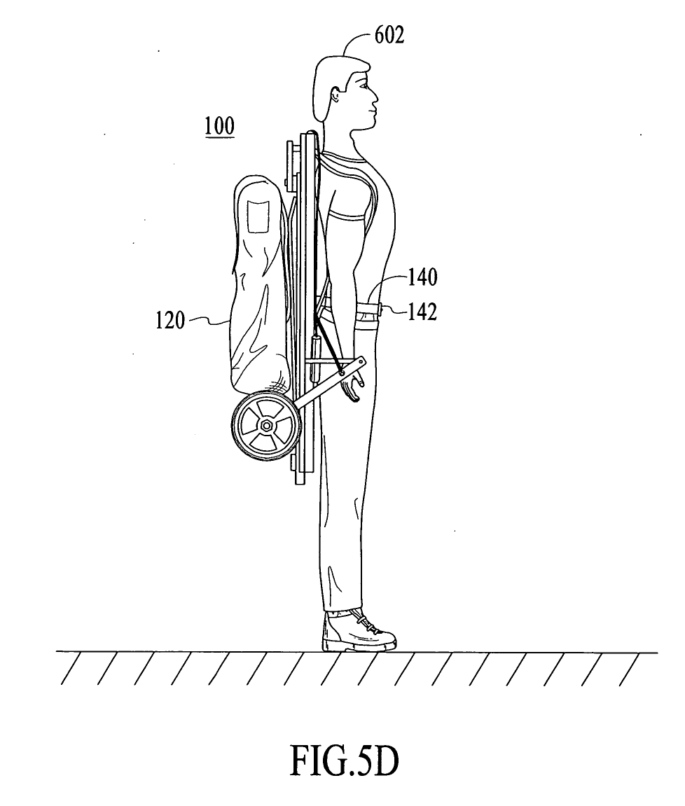

FIG. 5A, 5B, 5C and 5D are representative side views showing the apparatus and method of use of an embodiment of a trailable backpack 100 of the present invention switching from trailing mode to backpack/carrying mode. FIG. 5A shows user 602 is pulling the entire trailable backpack 100 of the present invention horizontally at shoulder straps 138 and waist belt/straps 140. As shown in FIG. 5B, while user 602 is pulling cables 404 at handles 408 in direction C, sliding bar 202 will be sliding in direction A and eventually the entire trailer portion 106 will be lifted. In an embodiment, with ratchet roll brakes 510 installed, every time user 602 stops pulling, position will be locked automatically. As shown in FIG. 5C, sliding bar 202 is slid to the top of vertical poles 103 and the backpack/carrying mode position is locked. In an embodiment, the weight of wheels 108 will automatically make leg extension portion 111 revolve at connection joint 113 in direction D. As shown in FIG. 5D, the backpack/carrying mode is completed and user 602 bears the entire weight of trailable backpack 100 of the present invention on his shoulders and waist/hip area only.

The entire process can be reversed by releasing ratchet brake release 502 in handles 408 to release ratchet roll brakes 510.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A trailable backpack which can be used alternatively as a conventional, shoulder-mounted backpack and as a wheeled trailer coupled to the upper torso of a user, the trailable backpack comprising the following:
a shoulder-supported carrying frame structure having shoulder straps and one or more rigid, essentially vertical support members; and
a trailable portion having one or more rotatable wheels, an enclosure portion, and a coupling portion slidably attached to the one or more vertical support members.

2. The trailable backpack of claim 1 further comprising manually operated hoisting mechanism for manually repositioning the trailable portion adjacent the shoulder supported carrying frame structure.

3. The trailable backpack of claim 2 in which the manually operated hoisting mechanism comprises one or more handle portions.

4. The trailable backpack of claim 2 in which the manually operated hoisting mechanism comprises a ratchet-operated, locking mechanism drive assembly.

5. The trailable backpack of claim 1 further comprising a hydraulically operated hoisting mechanism for automatically repositioning the trailable portion adjacent the shoulder supported carrying frame structure.

6. The trailable backpack of claim 1 further comprising an electrically operated hoisting mechanism for automatically repositioning the trailable portion adjacent the shoulder supported carrying frame structure.

7. The trailable backpack of claim 1 in which the one or more rotatable wheels are coupled to the trailable portion with one or more leg extension portions.

8. The trailable backpack of claim 7 in which the one or more leg extension portions fold as desired.

9. The trailable backpack of claim 1 in which the coupling portion comprises a yoke portion.

10. The trailable backpack of claim 1 in which the one or more vertical support members comprise one or more tubular members.

11. The trailable backpack of claim 1 in which the coupling portion comprises one or more roller bearings and in which the one or more vertical support members comprise one or more tubular members having internal tracks, wherein the one or more roller bearings roll up and down the one or more internal tracks disposed within the vertical support members.

12. The trailable backpack of claim 1 in which the coupling portion comprises one or more roller bearings and in which the one or more vertical support members comprise one or more tubular members having external tracks, wherein the one or more roller bearings roll up and down the one or more external tracks disposed externally on the vertical support members.

13. A method of transporting goods using a trailable backpack, the trailable backpack having a shoulder supported frame and shoulder harness and a wheeled trailer portion having an enclosure for carrying goods positionably attached thereto, the method comprising the following steps:
Supporting the trailable backpack on a user's shoulders;
Pulling the trailable backpack while the wheel of the trailer portion rolls over the ground as desired; and
Re-positioning the wheeled trailer portion and enclosure such that the weight of the wheeled trailer portion is fully supported off the ground by the shoulder harness.

14. A combination trailable backpack for use carrying goods over a variety of types of terrain, the trailable backpack comprising, in combination:
a backpack-type harness portion;
a rigid, essentially vertical support member coupled to the shoulder harness portion;
a trailable portion having a yoke section coupled to the essentially vertical support member such that the yoke can be slidably moved parallel with the vertical support member, the trailable portion having an openable and closeable enclosure portion for storing goods to be transported, the trailable portion having a wheel for providing rolling support to the trailable portion, such that when the yoke is moved to a position in a lower part of the vertical support member, the wheel provides rolling support to the trailable portion and when the yoke is moved to a position in an upper part of the vertical support member, the wheel rises off the ground and the entire trailable backpack is supported by the backpack-type harness portion.

15. The combination trailable backpack of claim 13 wherein the backpack -type harness comprises one or more shoulder straps.

16. The combination trailable backpack of claim 13 wherein the backpack -type harness comprises a waist support device.

17. The combination trailable backpack of claim 16 wherein the waist support device comprises a padded wait support portion.

18. The combination trailable backpack of claim 16 wherein the waist support device comprises a releasable and adjustable clasp.
